(19) United States
(12) Patent Application Publication
(10) Pub. No.: US 2002/0113747 A1
(43) Pub. Date: Aug. 22, 2002

(54) Transmitter and receiver coil

(76) Inventors: Virginie Tessier, Monza (FR); Xavier Baudard, rue de i'Assomption (FR); Alain Gascher, rue du Dahomey (FR)

Correspondence Address: Longacre & White, 6550 Rock Spring Drive Suite 240, Bethesda, MD, 20817, US

(21) Appl. No.: 10/030,261

(22) PCT Filed: May 4, 2001
(86) PCT No.: PCT/FR01/01486

(30) Foreign Application Priority Data
May 12, 2000 (FR) 00006040

(51) Int. Cl. H01Q 1/00; H01Q 1/36

(52) U.S. Cl. 343/787; 343/895

(57) ABSTRACT

The communication facility for system for low frequency communication by electromagnetic coupling, comprises at least one electromagnetic field transmitting and/or receiving antenna in the form of a coil (2) disposed on a substrate board (1) serving as support, this board having a certain thickness. The coil has turns which are wound in the thickness of the substrate board so that the sensitivity of the antenna can be improved without increasing the thickness of the communication facility.

The invention pertains to a communication facility for system for low frequency communication by electromagnetic coupling, comprising at least one electromagnetic field transmitting and/or receiving antenna in the form of a coil disposed on a substrate board serving as support, this board having a certain thickness.

Such a system for low frequency communication by electromagnetic coupling serves most especially as so-called “hands-free” access and starting system for a motor vehicle. It generally comprises an identification facility mounted on board the vehicle and able to control the opening of the openable panels of the vehicle as well as the starting of the engine of the vehicle. It also comprises an identifying facility intended to be carried by the user of the vehicle and which is able to communicate by electromagnetic coupling with the identifier facility so that if the identifier facility is recognized by the identifying facility while the user is located in proximity to its vehicle, the openable panels of the vehicle are automatically opened and/or the engine of the vehicle is automatically started.

The identifying facility generally forms an integral part of a flat badge or of a keyring. The reception antenna of this identifying facility which is an electromagnetic coil is generally placed on a small interface package itself fixed to the substrate board.

The aim of the invention is to propose such a communication facility whose electromagnetic field reception coil is more compact in shape and may also be more sensitive, cheaper and sturdier.

Accordingly, the subject of the invention is a communication facility such as defined above, characterized in that the coil has turns which are wound in the thickness of the substrate board. With this construction, the thickness of the communication facility can be decreased while increasing the dimensions of the turns of the coil.

According to one embodiment of the communication facility according to the invention, the board is furnished with a recess and the coil is sunk into said recess.

According to yet another embodiment of the communication facility according to the invention, the turns of the coils are wound around the substrate board and preferably the substrate board is partially laden with ferrite so as to constitute a core for the coil.

According to yet another embodiment of the communication facility according to the invention, each turn of the coil is constituted by a conducting track on a first face of the substrate board, a second conducting track on a second face of the substrate board opposite from the first face and by two conducting feedthroughs passing through the thickness of the substrate board and linking the first and the second conducting track.

These last two embodiments give the communication facility increased resistance to the impacts which tend to dislodge the coil from the support board.

The above exemplary embodiments of the communication facility according to the invention are described below in detail and illustrated in the drawings.

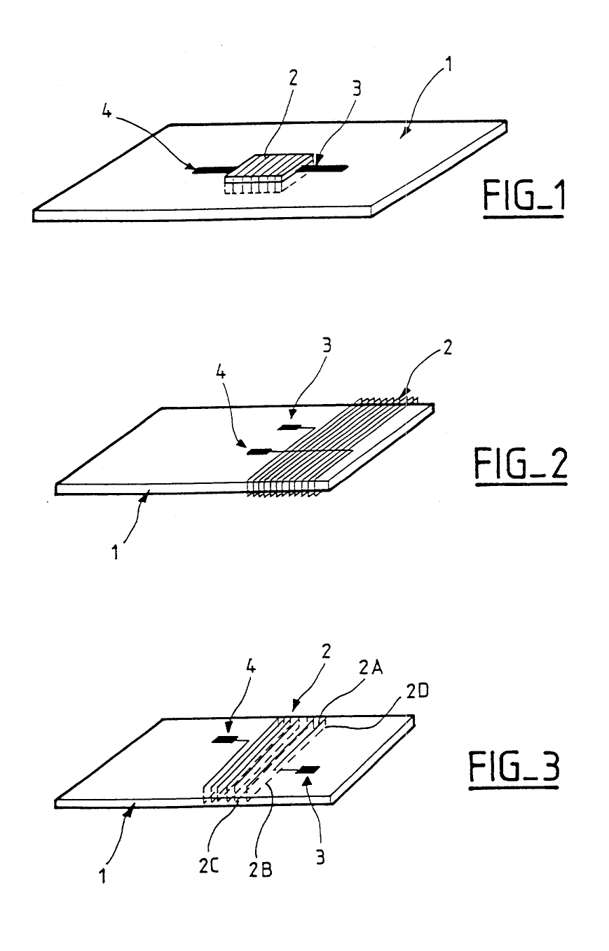

FIG. 1, the communication facility comprises a substrate board (printed circuit board) having a certain thickness and serving as support for an electro-conducting coil 2 forming the electromagnetic field reception antenna of the communication facility. The coil 2 is sunk into a recess provided in the substrate board. Hence, the turns of the coil are wound, preferably around a ferrite core, in the thickness of the substrate board. The terminals 3 and 4 of the coil are etched on the substrate board.

In FIG. 2, the turns of the coil 2 are wound around the substrate board 1 which is preferably partially laden with ferrite in the zone of winding of the turns, or else be made of a magnetic or plasto-ferrite material so as to constitute a core for the coil. The terminals 3, 4 of the coil are etched on the substrate board.

In FIG. 3, each turn of the coil 2 is constituted by a first conducting track 2A on a first face of the substrate board, a second conducting track 2B on a second face of the substrate board opposite from the first face and by two conducting feedthroughs 2C, 2D passing through the thickness of the substrate board and linking the first and the second conducting track. The terminals 3 and 4 of the coil are again etched on the substrate board 1. As before, the substrate board 1 may be partially laden with ferrite in the zone of winding of the turns, or else be made of a magnetic or plasto-ferrite material so as to constitute a core for the coil.

The ferrite core of the coil 2 serves in particular to increase the inductance of the coil and hence its sensitivity without increasing the thickness of the communication facility.

1. A communication facility for system for low frequency communication by electromagnetic coupling, comprising at least one electromagnetic field transmitting and/or receiving antenna in the form of a coil (2) disposed on a substrate board (1) serving as support, this board having a certain thickness, characterized in that the coil has turns which are wound in the thickness of the substrate board.

2. The facility as claimed in claim 1, in which the board is furnished with a recess and the coil is sunk into said recess.

3. The facility as claimed in claim 1, in which the turns of the coils are wound around the substrate board.

4. The facility as claimed in claim 1, in which each turn of the coil is constituted by a conducting track (2A) on a first face of the substrate board, a second conducting track (2B) on a second face of the substrate board opposite from the first face and by two conducting feedthroughs (2C, 2D) passing through the thickness of the substrate board and linking the first and the second conducting track.

5. The facility as claimed in claim 3 or 4, in which the substrate board is made of a material partially laden with ferrite or magnetic material or plasto-ferrite material so as to constitute a core for the coil.
